(19) United States
(12) Patent Application Publication
(10) Pub. No.: US 2013/0065991 A1
(43) Pub. Date: Mar. 14, 2013

(54) VIBRATION-PROOF RUBBER COMPOSITION FOR AUTOMOBILE

(71) Applicant: Min Soo Kim, Jinju (KR)

(72) Inventor: Min Soo Kim, Jinju (KR)

(73) Assignees: KIA MOTORS CORPORATION, Seoul (KR); HYUNDAI MOTOR COMPANY, Seoul (KR)

(21) Appl. No.: 13/299,657

(22) Filed: Nov. 18, 2011

(30) Foreign Application Priority Data
Sep. 8, 2011 (KR) 10-2011-0091475

(51) Int. Cl. C08K 13/02; C08L 9/00; C08L 9/06; C08L 7/00

(52) U.S. Cl. 524/87; 524/106; 524/236; 524/254

(57) ABSTRACT

Disclosed is a vibration-proof rubber composition having improved physical properties such as dynamic ratio, loss factor, etc. without sacrificing, for example, long-term durability. More particularly, the vibration-proof rubber composition, which contains a natural rubber as well as a styrene-butadiene rubber or a butadiene rubber as base rubber together with a filler and suitable additives, provides improved comfort, driving stability and impact shock of an automobile by improving dynamic ratio and loss factor while maintaining long-term durability.

### CROSS-REFERENCE TO RELATED APPLICATIONS

This application claims priority under 35 U.S.C. §119 to Korean Patent Application No. 10-2011-0091475, filed on Sep. 8, 2011, in the Korean Intellectual Property Office, the disclosure of which is incorporated herein by reference in its entirety.

### BACKGROUND

(a) Technical Field

The present invention relates to a vibration-proof rubber composition having improved physical properties such as dynamic ratio, loss factor, etc. without sacrificing, for example, long-term durability.

(b) Background Art

In the automotive field, the term “vibration-proof rubber” refers to a rubber used for preventing noise, vibration and harshness (NVH). Vibration-proof rubber prevents vibrations transmitted from a motor, an engine, or the like from being transferred to the interior compartment of the vehicle by absorbing kinetic energy. The bushings used in automobiles, such as stabilizer bar bushings, suspension bushings, etc., however, should have sufficient durability against externally applied force in order to improve NVH performance and thus to improve ride comfort.

For example, Korean Patent Application Publication No. 2011-11010 discloses a bushing rubber composition with improved aging properties, fatigue resistance, high damping property, etc., which comprises a base rubber comprising a natural rubber and a synthetic rubber, e.g., styrene-butadiene rubber, as well as sulfur, a vulcanization accelerator, an activator, an anti-aging agent, a dispersing agent, processing oil and carbon black. And, Korean Patent Registration No. 802811 discloses a rubber composition for a stabilizer bar bushing improving low compression set, which comprises a base rubber comprising a natural rubber and a synthetic rubber, e.g., butadiene rubber and ethylene-propylene rubber, as well as a sulfur crosslinking agent, a vulcanization accelerator, a filler (ISAF or HAF), an activator and an anti-aging agent.

Despite research which has been conducted on long-term durability and breakage problems during the past few years as described above, customers are still complaining about the noise and vibrations occurring from the engine room and chassis of automobiles with heightened expectations for ride comfort and driving stability. Thus, functional vibration-proof parts are consistently developed to solve this problem. For example, sound absorbing and insulating materials have been used to prevent the noise and vibration from the engine room and road surface and the design of the engine mount has also been modified. However, these solutions are costly and require a change in tuning values resulting from hardening of rubber parts, thus, resulting again in noise.

### SUMMARY

The present invention is directed to providing a vibration-proof rubber composition having improved physical properties such as dynamic ratio, loss factor, etc. without sacrificing, for example, long-term durability.

In one general aspect, the present invention provides a vibration-proof rubber composition containing: 100 parts by weight of base rubber containing 60-80 wt % of a natural rubber and 20-40 wt % of a synthetic rubber selected from a butadiene rubber and a styrene-butadiene rubber; 20-50 parts by weight of carbon black having an average particle size of 20-50 nm; 3-7 parts by weight of one or more anti-aging agent selected from amine, quinoline and imidazole; 1-3 parts by weight of a wax-based anti-ozone agent; 1-3 parts by weight of a sulfur crosslinking agent; 1-3 parts by weight of one or more vulcanization accelerator selected from sulfide and sulfenamide; and 5-10 parts by weight of an activator selected from zinc oxide and stearic acid.

The above and other aspects and features of the present invention will be described infra.

### DETAILED DESCRIPTION

Hereinafter, reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

A vibration-proof rubber composition according to the present invention comprises a base rubber, a carbon black filler, an anti-aging agent, an anti-ozone agent, a sulfur crosslinking agent, a vulcanization accelerator and an activator, as well as other additives commonly used in the art. The constituents of the vibration-proof rubber composition according to the present invention will be described in detail below.

The vibration-proof rubber composition of the present invention comprises a rubber as a base component. The rubber comprises a natural rubber and a synthetic rubber. For the synthetic rubber, a butadiene rubber with superior flexibility and resilience, low dynamic ratio and low cis content, a styrene-butadiene rubber with superior insulating property and high loss factor, or a mixture thereof is used. In the present invention, the mixing ratio of the natural rubber and the synthetic rubber is optimized to achieve improved dynamic ratio and loss factor of the rubber material as compared to when the natural rubber is used alone. The base rubber of the present invention, which comprises 60-80 wt % of a natural rubber and 20-40 wt % of a synthetic rubber, provides enhanced NVH performance without sacrificing physical properties of the material.

In the present invention, noise and vibration are reduced while maintaining durability by using a combination of the natural rubber and the synthetic rubber as the base rubber. And, the long-term durability problem resulting from the use of the synthetic rubber was resolved by adding a filler, an anti-aging agent, etc., with their controlled contents within the composition.

The filler included in the vibration-proof rubber composition of the present invention is carbon black having an average particle size of 20-50 nm. It serves to improve mechanical and insulating properties. The physical properties of the rubber material may change greatly depending on the average particle size of carbon black. When the average particle size is too small, the effect of improving vibration insulating property and resilience cannot be expected. Meanwhile, if the average particle size is too large, improvement of damping performance cannot be expected. Specifically, the carbon black having the above-described particle size may be used in an amount of 20-50 parts by weight based on 100 parts by weight of the base rubber. When the amount of the carbon black is too small, the effect of addition cannot be expected. Meanwhile, if it is too large, the anti-vibration performance may degrade due to decreased flexibility of the rubber.

The vibration-proof rubber composition of the present invention comprises an anti-aging agent and an anti-ozone agent in order to improve the long-term durability of an automobile. To improve heat resistance or fatigue resistance, one or more selected from amine, quinoline and imidazole is used as the anti-aging agent. Specifically, one or more selected from N-phenyl-N′-1,3-dimethylbutyl-p-phenylenediamine (6-PPD), N-phenyl-N′-isopropyl-p-phenylenediamine (3C), polymerized 2,2,4-tri methyl-1,2-dihydroquinoline (TMQ) and 2-mercaptobenzimidazole (MB) may be used. The anti-aging agent may be used in an amount of 3-7 parts by weight based on 100 parts by weight of the base rubber. When the amount of the anti-aging agent is too small, the anti-aging cannot be expected. And, when it is too large, the production cost increases.

The anti-ozone agent enhances the durability of the rubber material by preventing the breakage of double bonds of the rubber by oxygen. In the present invention, a wax-based anti-ozone agent may be used. The anti-ozone agent may be used in an amount of 1-3 parts by weight based on 100 parts by weight of the base rubber. When the amount of the anti-ozone agent is too small, the enhancement of durability cannot be expected. And, when it is too large, the production cost increases.

Sulfur is used for the crosslinking agent. The sulfur crosslinking agent may be a conventional vulcanizate with a high sulfur content. Alternatively, a semi-efficient vulcanizate that promotes sulfur crosslinking may be used to reduce the distance between rubber chains, thereby improving heat resistance and crosslinking density. The sulfur crosslinking agent may be used in an amount of 1-3 parts by weight based on 100 parts by weight of the base rubber. When the amount of the sulfur crosslinking agent is too small, endurance properties may be insufficient for use in bushings. And, when it is too large, heat resistance may degrade under the operation temperature range.

The vulcanization accelerator improves durability by promoting sulfur crosslinking. For the vulcanization accelerator, one or more selected from sulfide and sulfenamide is used. Specifically, one or more selected from 2,2′-dibenzamidodiphenyl disulfide (DBD), tetrabenzylthiuram disulfide (TBzTD), and N-cyclohexylbenzothiazyl-2-sulfenamide (CZ) may be used. The vulcanization accelerator may be used in an amount of 1-3 parts by weight based on 100 parts by weight of the base rubber. When the amount of the vulcanization accelerator is too small, durability may be insufficient due to insufficient vulcanization because an effective crosslinking system is not formed. And, when it is too large, scorch may occur.

The activator activates the crosslinking accelerator. In the present invention, stearic acid or zinc oxide (ZnO) may be used. The activator may be used in an amount of 5-10 parts by weight based on 100 parts by weight of the base rubber. When the amount of the activator is too small, the sulfur crosslinking reaction may be too slow. And, when it is too large, productivity problem may occur because of too fast crosslinking.

As described above, the vibration-proof rubber composition of the present invention has remarkably improved heat resistance, dynamic ratio and loss factor through control of the base rubber composition, the particle size of carbon black used as the filler, and the contents of the anti-aging agent and the vulcanization accelerator. In addition, the vibration-proof rubber composition of the present invention is capable of improving impact shock, driving stability and ride comfort of an automobile as compared to the existing vibration-proof rubber without sacrificing durability. Accordingly, the vibration-proof rubber composition of the present invention can be usefully used for bushings requiring high durability and NVH performance.

### EXAMPLES

The examples and experiments will now be described. The following examples and experiments are for illustrative purposes only and not intended to limit the scope of this invention.

### Comparative Example and Examples 1-3

As a vibration-proof rubber material with improved durability and NVH performance, samples were prepared according to the composition described in Table 1.

Specifically, a natural rubber and a synthetic rubber were masticated in a Banbury mixer. Then, after adding a carbon black filler, followed by kneading, an anti-aging agent, an anti-ozone agent and an activator were added and mixed. After kneading for about 5 minutes, followed by adding sulfur and a vulcanization accelerator, a final master batch (FMB) was prepared in an open roll for about 2 minutes. After determination of an adequate cure time using a flowmeter, the resulting rubber composition was compressed at 160° C. with a pressure of 210 kgf/cm² to prepare the sample.

TABLE 1

| | | Composition | | | |
|---|---|---|---|---|---|
| | | (parts by weight) | | | |
| | | Comp. | Ex. | | |
| | Components | Ex. | 1 | 2 | 3 |
| Base rubber | NR | 100 | 70 | 70 | 70 |
| | BR | 0 | 30 | 30 | 0 |
| | SBR | 0 | 0 | 0 | 30 |
| Carbon black | N330 | 40 | 15 | 0 | 35 |
| | N550 | 0 | 20 | 30 | 0 |
| Anti-aging agent | 6-PPD | 2 | 1.5 | 0 | 1.5 |
| | Kumanox 3C | 0 | 0 | 1.5 | 1 |
| | TMQ | 1.5 | 2 | 1.5 | 2 |
| | MB | 0 | 1 | 0 | 1 |
| Anti-ozone agent | Sunnoc-DW | 2 | 1 | 0 | 1.5 |
| | Sunplax 682 | 0 | 0 | 2.5 | 1 |
| Sulfur Crosslinking | S | 2.5 | 1.5 | 1.2 | 1.5 |
| agent | | | | | |
| Vulcanization | DBD | 0 | 0 | 0.5 | 0.5 |
| accelerator | CZ | 1 | 1 | 1 | 0.8 |
| | TBzTD | 0 | 1 | 1.2 | 0.5 |
| Activator | ZnO | 5 | 5 | 5 | 5 |
| | Stearic acid | 2 | 2 | 2 | 2 |

TABLE 2

| | Description of the components in Table 1 |
|---|---|
| Base rubber | NR (natural rubber): SMR-CV60 |
| | BR (butadiene rubber): KBR-01 (Kumho Petrochemical) |
| | SBR (styrene-butadiene rubber): KOSYN 1502 (Kumho |
| | Petrochemical) |
| Carbon black | N330: average particle size 20-30 nm (Korex Korea) |
| | N550: average particle size 40-50 nm (Korex Korea) |
| Anti-aging | 6-PPD: |
| agent | N-phenyl-N′-1,3-dimethylbutyl-p-phenylenediamine, |
| | Vulcanox 4020 (LG Lanxess) |
| | Kumanox 3C: |
| | N-phenyl-N′-isopropyl-p-phenylenediamine |
| | (Kumho Monsanto) |
| | TMQ: 2,2,4-trimethyl-1,2-dihydroquinoline, |
| | polymerized, Vulcanox HS (LG Lanxess) |
| | MB: 2-mercaptobenzimidazole (Nurchem) |
| Anti-ozone | Sunnoc-DW: Dae Woon Industry |
| agent | Sunplax 682: Yongjin Fine Chemical |
| Sulfur | S: sulfur |
| crosslinking | |
| agent | |
| Vulcanization | DBD (2,2′-dibenzamidodiphenyldisulphide): |
| accelerator | Renacit 11WG (Lanxess) |
| | CZ: (N-cyclohexylbenzothiazyl-2-sulfenamide): |
| | Newmix CZ-75N (Wooshin Chemtech) |
| | TBzTD (tetrabenzylthiuram disulfide): Henan Kingway |
| Activator | Zinc oxide (ZnO): 99.5% (Hanil Chemical Ind. Co., Ltd.) |
| | Stearic acid (Dansuk Industrial Co., Ltd.) |

### Test Example

Physical properties of the vibration-proof rubber compositions prepared in Comparative Example and Examples 1-3 were tested as follows. The result is given in Table 3.

1) Hardness was measured according to KS M 6784.

2) Tensile strength and elongation were measured according to KS M 6782 using No. 3.

3) Dynamic ratio and loss factor were measured using a dynamic property testing machine with 20% static stretching and 2% dynamic elongation under frequency excitation.

TABLE 3

| | | Comp. | Ex. | | |
|---|---|---|---|---|---|
| | | Ex. | 1 | 2 | 3 |
| State | Hardness | 58 | 56 | 62 | 56 |
| properties | (Hs) | | | | |
| | Tensile | 210 | 161 | 197 | 220 |
| | strength | | | | |
| | (kgf/cm²) | | | | |
| | Elongation | 530 | 440 | 470 | 450 |
| | (%) | | | | |
| Aging | Hardness | +10 | +5 | +5 | +6 |
| properties | change | | | | |
| | (ΔHs) | | | | |
| | Tensile | −21 | −9 | −11 | −5 |
| | strength | | | | |
| | change (%) | | | | |
| | Elongation | −42 | −7 | −16 | +9 |
| | change (%) | | | | |

| | | | | |
|---|---|---|---|---|
| Compression set | 55 | 16 | 9 | 21 |
| (100° C. × 22 hr) | | | | |
| Dynamic ratio | 3.2 | 1.8 | 2.3 | 2.5 |
| (@ 15 Hz) | | | | |
| Loss factor (@ 15 Hz) | 0.15 | 0.11 | 0.17 | 0.30 |
| Fatigue resistance | 130,000 | 140,000 | 500,000 | 300,000 |
| | cycles | cycles | cycles | cycles |

As seen from Table 3, the vibration-proof rubber compositions of Example 1-3 were superior in aging properties and compression set, which affect the long-term durability, as compared to that of Comparative Example. The vibration-proof rubber composition of Example 2 showed remarkably improved compression set, which is required for the components that are under high load for a long period of time. Dynamic ratio, which affects the ride comfort of an automobile, was improved by at least 40% in Example 1 as compared to Comparative Example. Loss factor, which affects impact shock and insulating property, was improved by 2 times in Example 3 as compared to Comparative Example.

The vibration-proof rubber composition of the present invention, which comprises a natural rubber and a synthetic rubber comprising a butadiene rubber and/or a styrene-butadiene rubber as the base rubber, is capable of preventing noise and vibration while maintaining durability. Also, the vibration-proof rubber composition of the present invention provides improved dynamic ratio and loss factor, which is related with impact shock and insulating property, by including carbon black with a specific particle size distribution as the filler.

The vibration-proof rubber composition of the present invention provides improved vibration insulating property by optimally mixing the base rubber, the carbon black filler, the activator and the anti-aging agent, while preventing degradation of long-term durability by using a combination of the natural rubber and the synthetic rubber as the base rubber.

The present invention has been described in detail with reference to specific embodiments thereof. However, it will be appreciated by those skilled in the art that various changes and modifications may be made in these embodiments without departing from the principles and spirit of the invention, the scope of which is defined in the appended claims and their equivalents.

What is claimed is:

1. A vibration-proof rubber composition comprising:
100 parts by weight of base rubber comprising 60-80 wt % of a natural rubber and 20-40 wt % of a synthetic rubber selected from a butadiene rubber and a styrene-butadiene rubber;
20-50 parts by weight of carbon black having an average particle size of 20-50 nm;
3-7 parts by weight of one or more anti-aging agent selected from amine, quinoline and imidazole;
1-3 parts by weight of a wax-based anti-ozone agent;
1-3 parts by weight of a sulfur crosslinking agent;
1-3 parts by weight of one or more vulcanization accelerator selected from sulfide and sulfenamide; and
5-10 parts by weight of an activator selected from zinc oxide and stearic acid.

2. The vibration-proof rubber composition according to claim 1, wherein the carbon black has an average particle size of 40-50 nm.

3. The vibration-proof rubber composition according to claim 1, wherein the anti-aging agent is one or more selected from N-phenyl-N′-1,3-dimethylbutyl-p-phenylenediamine (6-PPD), N-phenyl-N′-isopropyl-p-phenylenediamine (3C), polymerized 2,2,4-tri methyl-1,2-dihydroquinoline (TMQ) and 2-mercaptobenzimidazole (MB).

4. The vibration-proof rubber composition according to claim 1, wherein the vulcanization accelerator is one or more selected from 2,2′-dibenzamidodiphenyl disulfide (DBD), tetrabenzylthiuram disulfide (TBzTD), and N-cyclohexylbenzothiazyl-2-sulfenamide (CZ).

5. A bushing for a vehicle, the bushing composed of a vibration-proof rubber composition comprising:
100 parts by weight of base rubber comprising 60-80 wt % of a natural rubber and 20-40 wt % of a synthetic rubber selected from a butadiene rubber and a styrene-butadiene rubber;
20-50 parts by weight of carbon black having an average particle size of 20-50 nm;
3-7 parts by weight of one or more anti-aging agent selected from amine, quinoline and imidazole;
1-3 parts by weight of a wax-based anti-ozone agent;
1-3 parts by weight of a sulfur crosslinking agent;
1-3 parts by weight of one or more vulcanization accelerator selected from sulfide and sulfenamide; and
5-10 parts by weight of an activator selected from zinc oxide and stearic acid.

6. The bushing according to claim 5, wherein the carbon black has an average particle size of 40-50 nm.

7. The bushing according to claim 5, wherein the anti-aging agent is one or more selected from N-phenyl-N′-1,3-dimethylbutyl-p-phenylenediamine (6-PPD), N-phenyl-N′-isopropyl-p-phenylenediamine (3C), polymerized 2,2,4-tri methyl-1,2-dihydroquinoline (TMQ) and 2-mercaptobenzimidazole (MB).

8. The bushing according to claim 5, wherein the vulcanization accelerator is one or more selected from 2,2′-dibenzamidodiphenyl disulfide (DBD), tetrabenzylthiuram disulfide (TBzTD), and N-cyclohexylbenzothiazyl-2-sulfenamide (CZ).
